(19) United States
(12) Patent Application Publication
(10) Pub. No.: US 2009/0025289 A1
(43) Pub. Date: Jan. 29, 2009

(54) Botanical Animal Shelter

(76) Inventor: Karl Krieg, Houston, TX (US)

Correspondence Address: STORM LLP, BANK OF AMERICA PLAZA, 901 MAIN STREET, SUITE 7100, DALLAS, TX, 75202, US

(21) Appl. No.: 12/178,276

(22) Filed: Jul. 23, 2008

Related U.S. Application Data
(60) Provisional application No. 60/951,413, filed on Jul. 23, 2007.

(51) Int. Cl. A01K 1/00; A01G 9/02; A01K 1/02

(52) U.S. Cl. 47/66.6; 119/482

(57) ABSTRACT

An animal shelter incorporating a planter and associated water management system is provided. There is a chamber for receiving an animal, which is secured to a base at its bottom end. The base provides support for the animal shelter. A saucer is provided and is secured to the top end of the chamber. There is a bowl suitable for containing plant material which is secured to the top of the saucer. A fluid passage, extending through the bowl, saucer, and chamber, is provided for watering of the plant material. As such, an animal shelter is provided with improved aesthetic appeal and chamber climate control.

### CROSS-REFERENCE TO RELATED APPLICATION

This application claims priority to U.S. Provisional Patent Application No. 60/951,413, entitled “BOTANICAL ANIMAL SHELTER,” filed on behalf of inventor Karl Krieg, which is hereby incorporated by reference for all purposes.

### TECHNICAL FIELD

The invention relates generally to a animal shelter and, more particularly, to a animal shelter incorporated with a planter having a water management system.

### BACKGROUND

The provision of shelter for domestic pets is a common requirement for owners of such pets. Traditionally, pet shelters have been provided which are manufactured from various materials such as wood, metal, and plastic. Some examples of traditional devices for the care of pets are U.S. Pat. Nos. 3,542,069, 4,161,924, 5,791,293, and 6,951,187 and U.S. patent application Ser. No. 11/406,861. Such pet shelters can be used indoors or outdoors but typically share a common element: the structures are unsightly and detract from the overall aesthetic appeal of their surroundings. However, any such undesirable aesthetic qualities do not obviate the need to provide shelter to pets. Thus, a need is presented for an animal shelter which, while serving the basic shelter needs of domestic animals, does not significantly detract from the overall aesthetic appeal of its surroundings.

### SUMMARY

The present invention, accordingly, provides an apparatus for shelter an animal. The apparatus includes a base, a chamber, a saucer, and a bowl. The generally hollow chamber has an interior and an exterior. The chamber is secured to the base. An opening that extends from the exterior to the interior of the chamber that allows the animal to enter the chamber is also provided. Secured to the top of the chamber is a saucer and a bowl. A fluid passage is proved for automatic watering of the plant material in the bowl, through a passage in the chamber. A drain is provided between the bowl interior and the saucer.

In accordance with a preferred embodiment of the present invention, at least one clip secures the chamber to the saucer.

In accordance with a preferred embodiment of the present invention, at least one clip secures the saucer to the bowl. In a second embodiment, a second clip secures the saucer to the chamber.

In accordance with a preferred embodiment of the present invention, the liquid bearing material is a plant and soil.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a front elevation view of the shelter in accordance with a preferred embodiment of the present invention;

FIG. 2 is a side elevation view of the shelter of FIG. 1;

FIG. 3 is a side cross-sectional view of the shelter of FIG. 1;

FIG. 4 is an exploded isometric view of shelter of FIG. 1; and,

FIG. 5 is another exploded isometric view of the shelter of FIG. 1.

### DETAILED DESCRIPTION

Refer now to the drawings wherein depicted elements are, for the sake of clarity, not necessarily shown to scale and wherein like or similar elements are designated by the same reference numeral through the several views.

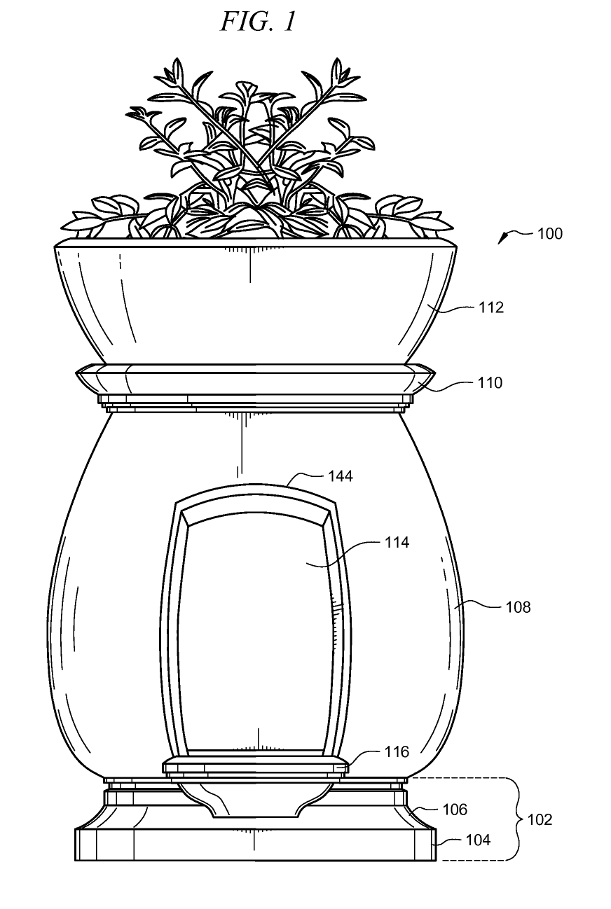

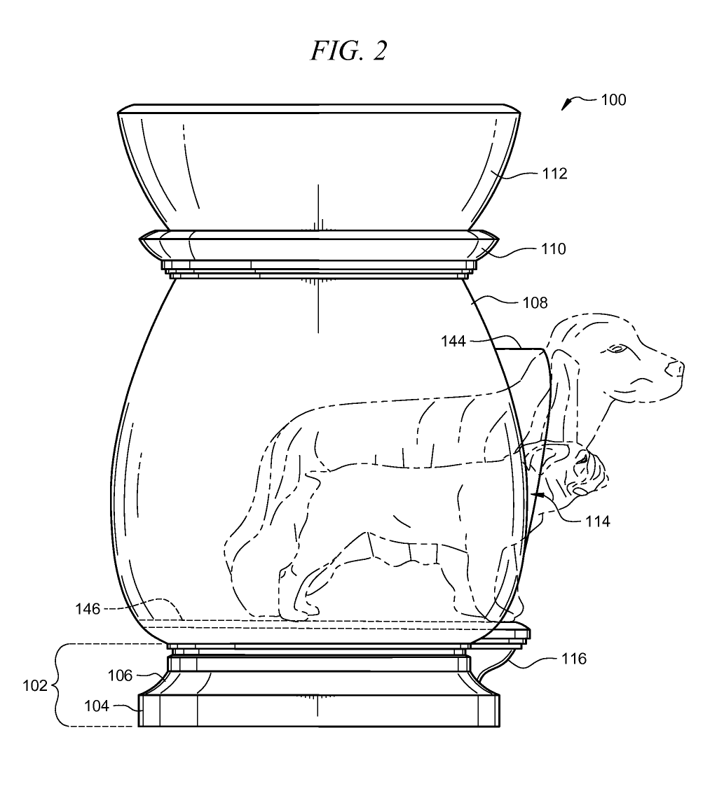

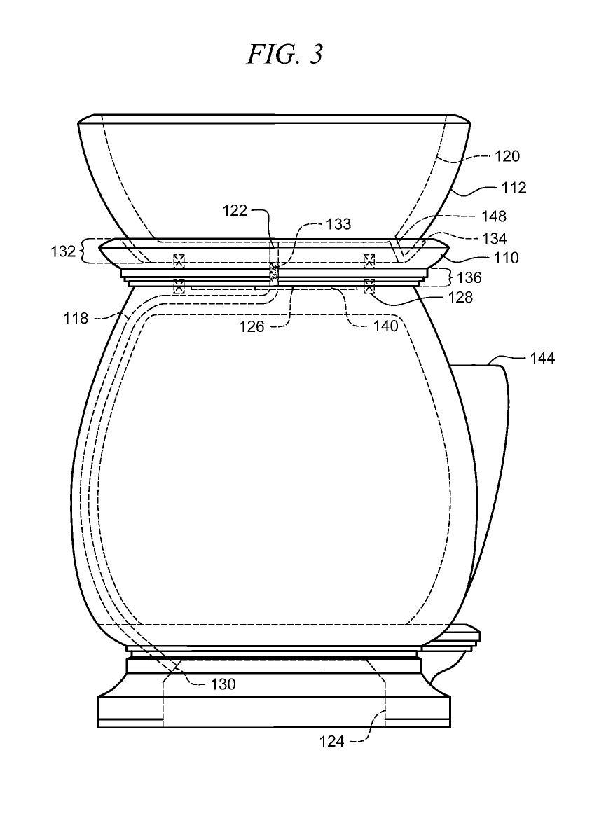

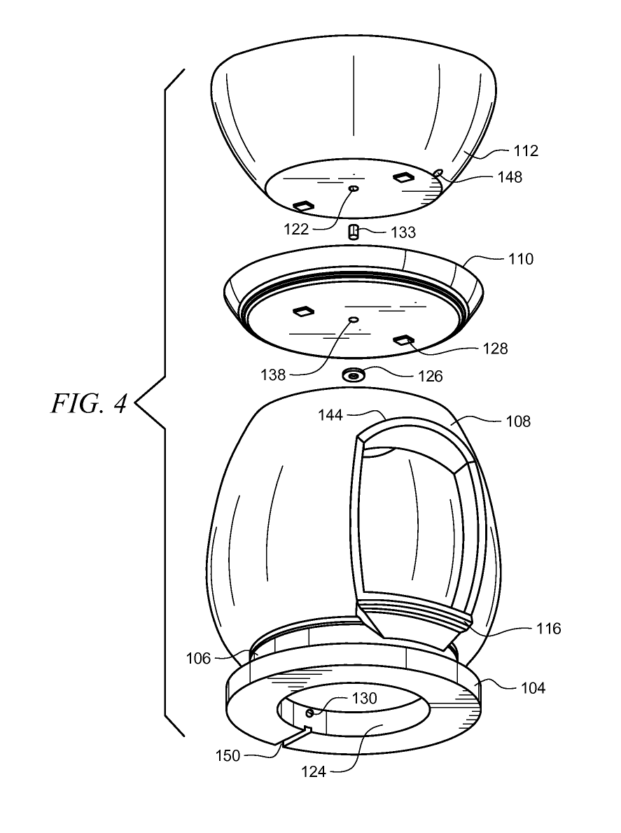

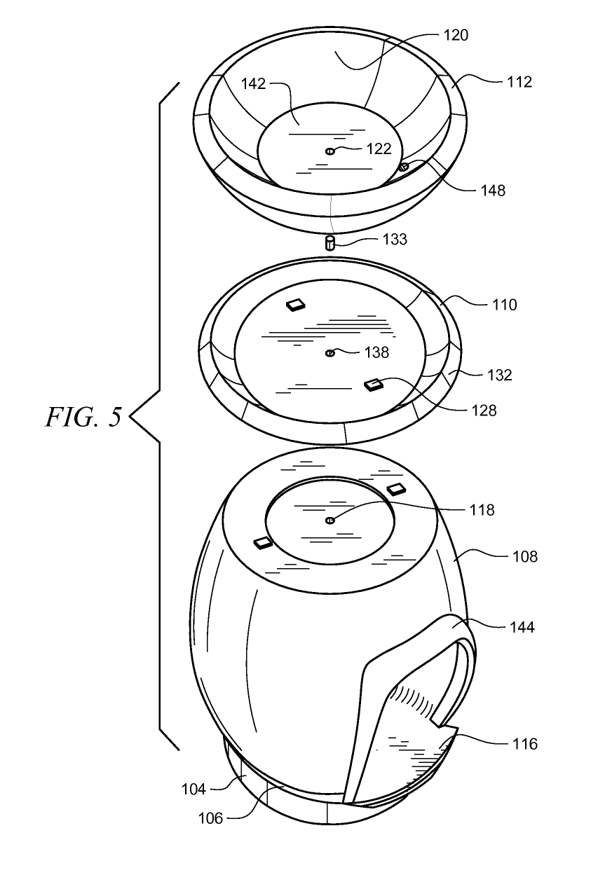

Referring to FIGS. 1-5 of the drawings, the reference numeral 100 generally designates an animal shelter system, which may be used to house a dog, cat, or other domesticated animal. Shelter 100 incorporates a potted plant system, including a bowl 112. By integrating a potted plant with shelter 100, both the climate and aesthetic appeal of the shelter can be improved. In the preferred embodiment, a water feed and drain system is provided for managing the moisture of the soil of the potted plant matter.

In particular, shelter 100 is comprised of four principal components: a base 102, a chamber 108, a saucer 110, and a bowl 112. Base 102 and chamber 108 together form the basic shelter for the animal. Bowl 112 is adapted for supporting a potted plant. Saucer 110 provides a stable coupling between chamber 108 and bowl 112 as well as a liquid reservoir. Each of base 102, chamber 108, saucer 110, and bowl 112 are preferably made of architectural (lightweight) concrete or plastic. In an alternative embodiment, base 102, chamber 108, saucer 110, and bowl 112 are a single cast piece.

Bowl 112 is a container having an open top. Bowl 112 preferably has a semi-spherical wall 120 and a flat bottom 142. In the preferred embodiment, the diameter of the open top is between about 24 and 28 inches. Bowl 112 is adapted to receive a plant in water-bearing soil. A drain 148 is located in wall 120, near bottom 142. A passage 122 is located near bowl 112 to allow transfer of liquid to or from bowl 112; for example, passage 122 can permit automatic watering. Optionally, a watering line can be attached to passage 122 to distribute the incoming fluid.

Bowl 112 is located on saucer 110. Saucer 110 has a generally planar disc member 136 and a circumferential ridge 132 that extends upwards therefrom, creating a space 134 above disc member 136 for location of bowl 112. Each of disc member 136 and ridge 132 can also include a profile along its circumference, such as an ogee or bevel, so as to provide different aesthetic features. In the preferred embodiment, bowl 112 rests on disc member 136, secured to saucer 110 by centering clips 128. Clips 128 match receptacles on bottom 142 of bowl 112. Clips 128 center bowl 112 on saucer 110, creating a generally uniform radial gap between the circumference of bowl 110 and ridge 132.

In the preferred embodiment, saucer 110 includes a passage 138 that extends through disc member 136 and in alignment with passage 122. Passage 138 and/or passage 122 can be closed by a rubber stopper 133 if desired. Optionally, a tube 139 can be provided to create an improved fluid connection between bowl 112 and saucer 110.

Chamber 108 is a generally hollow chamber. Optionally, chamber 108 may be frustoellipsoidal or oblate frustospherical shaped, having an upper frustum or end and a lower frustum or end. In the preferred embodiment, chamber 108 is between about 20 and 30 inches tall. In the preferred embodiment, chamber 108 is between about 24 and 26 inches wide.

A passage 118 is provided in the side wall of chamber 108, which extends into alignment at the top of chamber 108 with passage 138. Thus aligned, passage 118 is in fluid communication with passage 138 in bowl 112.

An opening 114 is provided in the wall of chamber 108 to allow an animal to enter the interior of chamber 108. In the preferred embodiment, a ledge 116 extends from the bottom of opening 114 such that the animal may step on ledge 116 to enter the interior of chamber 108. In the preferred embodiment, a canopy 144 prevents sun and rain and plant overgrowth from covering opening 114. In the preferred embodiment, chamber 108 has a floor 146 which is inclined so as to drain liquid towards opening 114.

Saucer 110 is centered on the top of chamber 108. In the preferred embodiment, saucer 110 is secured by clips 128 to chamber 108. Also in the preferred embodiment, a gap 140 is located between disc member 136 and chamber 108 for receiving a washer or seal 126 that is typically made of rubber. Washer 126 provides a seal between passage 138 and the first end of passage 118, which are generally aligned in fluid communication.

In the preferred embodiment, slot 150 is located opposite to opening 114 to hide from view the automatic watering system. When the plant is watered automatically thorough passage 118, 138 and 122, or watered by hand or otherwise, excess water may drain through drain 148. The space between ridge 132 and wall 120 of bowl 112 allows for accumulation of excess water passed by drain 148.

Secured to the lower end of chamber 108 is base 102, which typically rests on a ground surface. In the preferred embodiment, base 102 is integrally molded with chamber 108 or permanently affixed to the lower end of chamber 108 by an adhesive. Base 102 may be formed of two generally cylindrical members that are generally aligned: upper member 106 and lower member 104. The combination of upper member 106 and lower member 104 form a space 124 that is primarily used for insulation of chamber 108. A slot 150 is provided in lower member 104.

Space 124 provides optional drainage when passages 122, 138 and 118 are used in a drainage configuration. In a more preferred embodiment, an automatic feedline passes through slot 150 and connects to passage 118.

Passage 118 has a portal 130 that allows connection to a pipe or hose of an irrigation feedline. The feedline can exit space 124 through slot 150. Thus, excess fluid from bowl 112 can be drained through space 124 to the ground surface through portal 130, or the plant or other material may be irrigated by a feedline run through space 124 (allowing the shelter 100 to conceal the irrigation lines).

In the preferred embodiment, the interior walls of chamber 108 transition smoothly into floor 146, and have no interior corners. This prevents accumulation of debris and enhances the ease of cleaning chamber 108.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

I claim:

1. An apparatus for sheltering an animal and supporting a plant, comprising:
a base having a generally cylindrical upper member, a generally cylindrical lower member, and a first space formed therein, the upper member and the lower member secured to one another to form the first space;
a generally hollow chamber having an interior, an exterior, an upper end, and a lower end, the chamber being secured to the upper member at the lower end;
an opening extending from the exterior to the interior of the chamber that allows the animal to enter the chamber;
a saucer secured to the upper end of the chamber;
a bowl secured to the saucer having a second space formed therein for receiving a liquid bearing material; and
a passage extending from the first space to the second space allowing the first space to be in fluid communication with the second space.

2. The apparatus of claim 1, wherein at least one clip secures the chamber to the saucer.

3. The apparatus of claim 1, wherein at least one clip secures the saucer to the bowl.

4. The apparatus of claim 1, wherein the chamber is generally frustoellipsoidal in shape.

5. The apparatus of claim 1, wherein the chamber has a generally oblate frustospherical shape.

6. The apparatus of claim 1, wherein the liquid bearing material is a plant and soil.

7. An apparatus for sheltering an animal, comprising:
a generally cylindrical base member having a first space formed therein;
a chamber having an interior, an exterior, an upper end, and a lower end, the chamber being secured to the base member at the lower end;
an opening extending from the exterior to the interior of the chamber that allows the animal to enter the chamber;
a saucer secured to the upper end of the chamber;
a bowl secured to the saucer having a second space formed therein for receiving a liquid bearing material; and
a passage extending from the first space to the second space allowing the first space to be in fluid communication with the second space.

8. The apparatus of claim 7, wherein the base member further comprises:
a generally cylindrical upper member; and
a generally cylindrical lower member, the lower member being secured to the upper member.

9. The apparatus of claim 7, wherein at least one clip secures the chamber to the saucer.

11. The apparatus of claim 7, wherein at least one clip secures the saucer to the bowl.

12. The apparatus of claim 7, wherein the chamber is generally frustospherical in shape.

13. The apparatus of claim 7, wherein the chamber has a generally oblate frustospherical shape.

14. The apparatus of claim 7, wherein the liquid bearing material is a plant and soil.
